(19) United States
(12) Patent Application Publication
(10) Pub. No.: US 2011/0194641 A1
(43) Pub. Date: Aug. 11, 2011

(54) Method for Encoding a Bit Sequence and Encoding Circuit

(76) Inventors: Wei Ming Lim, Singapore (SG); Changlong Xu, Singapore (SG); Mituru Tanabe, Osaka (JP); Teruhito Takeda, Osaka (JP); Tomoaki Mizuta, Osaka (JP)

(21) Appl. No.: 12/678,146

(22) PCT Filed: Sep. 12, 2008
(86) PCT No.: PCT/SG2008/000345

§ 371 Date: Jul. 13, 2010

Related U.S. Application Data
(60) Provisional application No. 60/972,430, filed on Sep. 14, 2007.

(51) Int. Cl. H04L 27/00

(52) U.S. Cl. 375/295

(57) ABSTRACT

A method for encoding a bit sequence is described comprising selecting a first coding block bit number and a first coding scheme; sub-dividing the bit sequence into at least one first bit block and a second bit block, wherein each of the at least one first bit block comprises the first coding block bit number of bits and the second bit block comprises less bits than the first coding block bit number; selecting a second coding scheme for the second bit block different from the first coding scheme; and encoding the at least one first bit block using the first coding scheme and encoding the second bit block using the second coding scheme.

### FIELD OF THE INVENTION

Embodiments of the invention generally relate to a method for encoding a bit sequence and an encoding circuit.

### BACKGROUND OF THE INVENTION

In a wireless communication system according to IEEE 802.16-2004, for example, in which OFDM (Orthogonal Frequency Division Multiplexing) and TPC (Turbo Product Codes) are used, the size of the TPC blocks is designed to match the size of the OFDM symbols. The Turbo Product Code block formats used according to IEEE 802.16 are given in table 1.

TABLE 1
Block format used in IEEE 802.16-2004

| Constituent | Data bits | Coded bits | Coding |
|---|---|---|---|
| Types | per Block | per Block | Rate |
| (32, 16) (16, 11) | 23 | 48 | 0.48 |
| (32, 26) (16, 15) | 35 | 48 | 0.73 |
| (32, 26) (32, 26) | 58 | 96 | 0.60 |
| (64, 57) (16, 15) | 77 | 96 | 0.80 |
| (64, 63) (32, 26) | 96 | 144 | 0.67 |
| (32, 31) (64, 57) | 120 | 144 | 0.25 |

In such a communication system, two types of codes are used, the Extended Hamming Code and the Parity Check code. Parity Check code typically has lower coding gains than Extended Hamming Code.

Some high coding rates may be achieved by pairing Extended Hamming Code with Parity Check code. This, however, results in lower coding gain compared to using TPC codes formulated from Extended Hamming Codes only.

Conventionally, extensive row and column shortenings are employed to match the number of coded bits per block to one OFDM symbol.

The number of bits that can be transmitted in an OFDM symbol is largely determined by the channel conditions (i.e. the conditions of the communication channel that is used) and the types of Forward Error Correcting (FEC) code that may be used is determined by the allowed BER (Bit Error Rate). For achieving a high throughput, FEC codes are typically chosen such that the coding rate is high without compromising the BER performance.

In conventional systems where the size of the code (i.e. the block format of the code) is matched to the OFDM symbol size, the possibility to choose the size of the FEC codes such that high BER performance and coding rate is achieved may therefore be severely limited.

### SUMMARY OF THE INVENTION

In one embodiment, a method for encoding a bit sequence is provided including selecting a first coding block bit number and a first coding scheme; sub-dividing the bit sequence into at least one first bit block and a second bit block, wherein each of the at least one first bit block includes the first coding block bit number of bits and the second bit block includes less bits than the first coding block bit number; selecting a second coding scheme for the second bit block different from the first coding scheme; and encoding the at least one first bit block using the first coding scheme and encoding the second bit block using the second coding scheme.

### SHORT DESCRIPTION OF THE FIGURES

Illustrative embodiments of the invention are explained below with reference to the drawings.

FIG. 1 shows a flow diagram according to an embodiment.

FIG. 2 shows an encoding circuit according to an embodiment.

FIG. 3 shows a transmitter according to an embodiment.

FIG. 4 shows an OFDM frame according to an embodiment.

FIG. 5 shows a input data block according to an embodiment.

FIG. 6 shows an output code block according to an embodiment.

FIG. 7 shows a shortened output code block according to an embodiment.

FIG. 8 shows a shortened output code block according to an embodiment.

### DETAILED DESCRIPTION

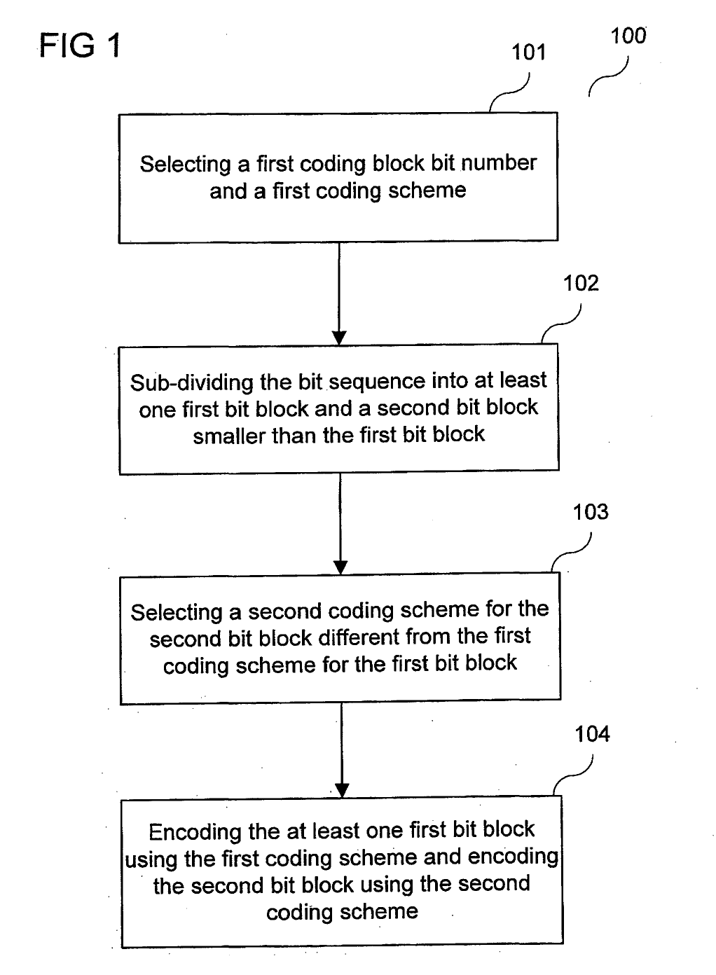

A method for encoding a bit sequence according to one embodiment is illustrated in FIG. 1.

FIG. 1 shows a flow diagram 100 according to an embodiment.

In 101, a first coding block bit number and a first coding scheme are selected.

In 102, the bit sequence is sub-divided into at least one first bit block and a second bit block, wherein each of the at least one first bit block includes the first coding block bit number of bits and the second bit block includes less bits than the first coding block bit number.

In 103, a second coding scheme is selected for the second bit block different from the first coding scheme.

In 104, the at least one first bit block is encoded using the first coding scheme and the second bit block is encoded using the second coding scheme.

In another embodiment, a computer program product according to the method described above is provided.

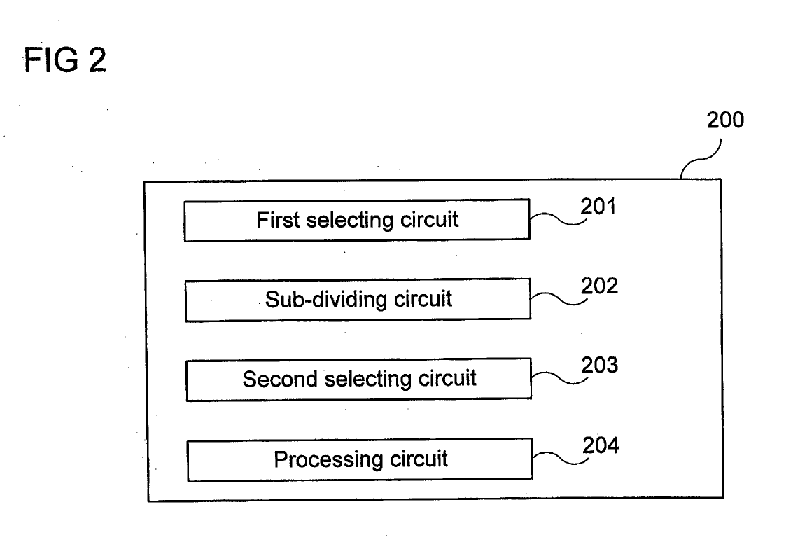

In another embodiment, an encoding circuit for encoding a bit sequence is provided. This is illustrated in FIG. 2.

FIG. 2 shows an encoding circuit 200 according to an embodiment.

The encoding circuit 200 includes a first selecting circuit 201 configured to select a first coding block bit number and a first coding scheme.

The encoding circuit 200 further includes a sub-dividing circuit 202 configured to sub-divide the bit sequence into at least one first bit block and a second bit block, wherein each of the at least one first bit block includes the first coding block bit number of bits and the second bit block includes less bits than the first coding block bit number.

A second selecting circuit 203 of the encoding circuit 200 is configured to select a second coding scheme for the second bit block different from the first coding scheme.

The encoding circuit 200 further includes a processing circuit 204 configured to encode the at least one first bit block using the first coding scheme and to encode the second bit block using the second coding scheme.

The encoding circuit 200 may further include a memory in which information (e.g. program code, parameter values, bit combination rules) about the coding schemes that may be selected is stored.

A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

The encoding circuit is for example part of a transmitter.

In one embodiment, in other words, a bit sequence to be encoded, for example for forward error correction (FEC), e.g. for a transmission of the bit sequence, is encoded by sub-dividing the bit sequence into input data blocks for one or more coding schemes. For example, the bit sequence is sub-divided into a plurality of input data blocks of given size for the first coding scheme such that the input data block bit size is maximal, i.e. the number of bits not associated with an input data block is too little for a complete input data block. These remaining bits are then grouped to form a second input data block, possibly with bit padding. This allows to choose a large block bit size for the first coding scheme, i.e. a high first coding block bit size number, without compromising the coding rate due to the fact that the remaining bits would be far too few for a input data block for the first coding scheme in which a high number of padding bits would be necessary. In one embodiment, the second coding scheme is therefore chosen such that the input data block for the second coding scheme is smaller than the input data block for the first coding scheme and thus, fewer padding bits are necessary compared to the case that the first coding scheme is used for the remaining bits. The second coding scheme is for example chosen such that all remaining bits fit into one input data block for the second coding scheme.

The first bit block is for example encoded to generate a first code block. The first bit block may be referred to as the input data block for the first coding scheme and the first code block may be referred to as the output data block of the first coding scheme. Similarly, the second bit block may be referred to as the input data block for the second coding scheme and the second code block to which the second bit block is encoded may be referred to as the output data block of the second coding scheme. The input data block of a coding scheme is for example a block of bits that are as a whole converted to the respective output data block. This means that the output data block for example depends on all the bits of the respective input data block, while output data blocks that correspond to different input data blocks are independent of each other. In particular, an output data block only depends on the values of the bits of its corresponding input data block.

The first coding scheme and the second coding scheme may be different, for example with regard to their input data block size and/or their output data block size.

In one embodiment, a method to encode data that allows high flexibility with regard to the selection of the coding schemes with respect to desired quality requirements such as BER performance and data throughput is provided.

In one embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be software being implemented or executed by a processor, e.g. any kind of computer program, e.g. a computer program using a virtual machine code such as e.g. Java. Any other kind of implementation of the respective functions which will be described in more detail below may also be understood as a “circuit” in accordance with an alternative embodiment. Embodiments described in the context of the method for encoding a bit sequence are analogously valid for the computer program product and the encoding circuit.

In one embodiment, the second coding scheme is selected based on the number of bits of the second bit block. For example, the second coding scheme is selected such that the input block size of the second coding scheme is larger than the number of bits of the second bit block. The second coding scheme is for example selected as the coding scheme of a plurality of second coding schemes that has the minimum input block size of the plurality of second coding schemes that is larger than the number of bits of the second bit block.

In one embodiment, the first coding block bit number is selected in accordance with the input block size of the first coding scheme.

In one embodiment, the bit sequence is encoded for a transmission of the bit sequence and the first coding scheme is selected based on a maximum allowed bit error rate of the transmission. For example, based on the maximum allowed bit error rate, a plurality of coding schemes which are suitable for the maximum allowed bit error rate are selected and the first coding scheme is selected as the coding scheme of the plurality of coding schemes having the highest coding rate and/or the highest coding gain.

In one embodiment, the first coding scheme is a product code, for example a turbo product code. For example, the first coding scheme is a turbo product code based on two Extended Hamming Codes.

In one embodiment, the second coding scheme is a product code, for example a turbo product code. For example, the second coding scheme is a turbo product code based on two Extended Hamming Codes. In other embodiments, the first coding scheme and/or the second coding scheme are based on other codes that are possibly different from each other, e.g. a parity code and a Hamming code, two parity codes, etc.

In one embodiment, the method further includes transmitting the encoded first bit block and the encoded second bit block. For example, the encoded first bit block and the encoded second bit block are transmitted according to OFDM.

In one embodiment, the method further includes mapping the data of the encoded first bit block and the data of the encoded second bit block to modulation symbols. The method for example further includes mapping the data of the encoded first bit block and the data of the encoded second bit block to OFDM symbols. In one embodiment, the data amount of the encoded first bit block is different from the amount of data that is mapped to one OFDM symbol. The data amount of the encoded first bit block for example refers to the number of bits of the encoded first bit block. This means that the size of the code blocks including the encoded first bit block is in this embodiment not matched to the size of the OFDM symbols.

In one embodiment, the data of the encoded first bit block are mapped to at least two OFDM symbols.

In one embodiment, the data amount of the encoded second bit block is different from the amount of data that is mapped to one OFDM symbol.

The method may further include bit padding the second bit block to be suitable as input for the second coding scheme.

In one embodiment, the method further includes omitting at least some of the zero bits from the encoded second bit block that arise from encoding the padding bits. For example, the method further includes omitting all zero bits from the encoded second bit block that arise from encoding the padding bits.

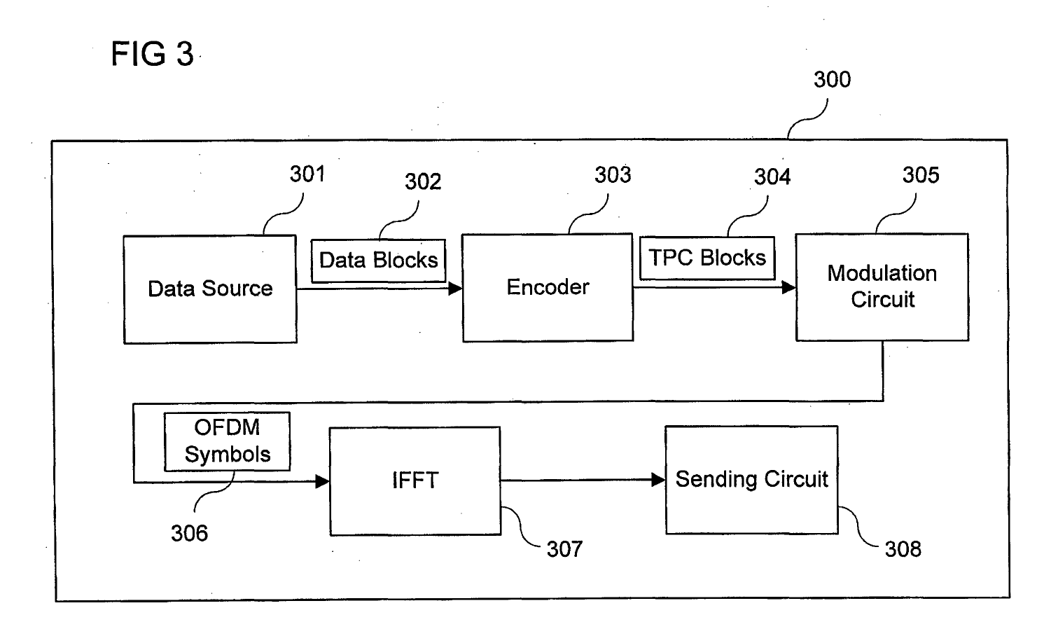

FIG. 3 shows a transmitter 300 according to an embodiment.

In this example, the transmitter 300 uses OFDM (Orthogonal Frequency Division Multiplexing) for sending data provided by a data source 301.

The data provided by the data source 301 is grouped into data blocks 302 which are fed to an encoding circuit 303. The encoding circuit 303 encodes the data blocks 302 according to its code block format. This means that the encoding circuit 303 uses an input data block including a certain number of bits (referred to as the number of (useful) data bits per code block in the following) from one or more data blocks 302 and generates from this input data block an output code block including a certain number of bits (referred to as the number of coded bits per code block in the following). The output code blocks are in this example referred to as TPC blocks, since in this example, the coding schemes used are assumed to be turbo product codes.

The TPC blocks 304 are fed to a modulation circuit 305 which generates a sequence of OFDM symbols 306 from the bits of the TPC blocks 304. Each OFDM symbol includes a modulation symbol, e.g. a modulation symbol according to QAM64 (QAM: Quadratur Amplitude Modulation) or PSK (Phase Shift Keying), for each sub-carrier used according to the OFDM scheme, e.g. 64 or 128 sub-carriers. The sequence of OFDM symbols 306 is grouped into OFDM frames, which form the basic transmission format.

The OFDM symbols 306 are then fed to an IFFT circuit 307 which performs an inverse fast Fourier transformation and provides its output to sending circuitry 308 which for example includes digital to analog conversion circuits, mixers, and one or more transmit antennas and transmits the output of the IFFT circuit 307 as a radio signal.

Please note that other circuits may be included in the transmitter 300. For example, there may be an interleaving circuit between the encoder 303 and the modulation circuit 305 that performs an interleaving of the bits of the TPC blocks 304.

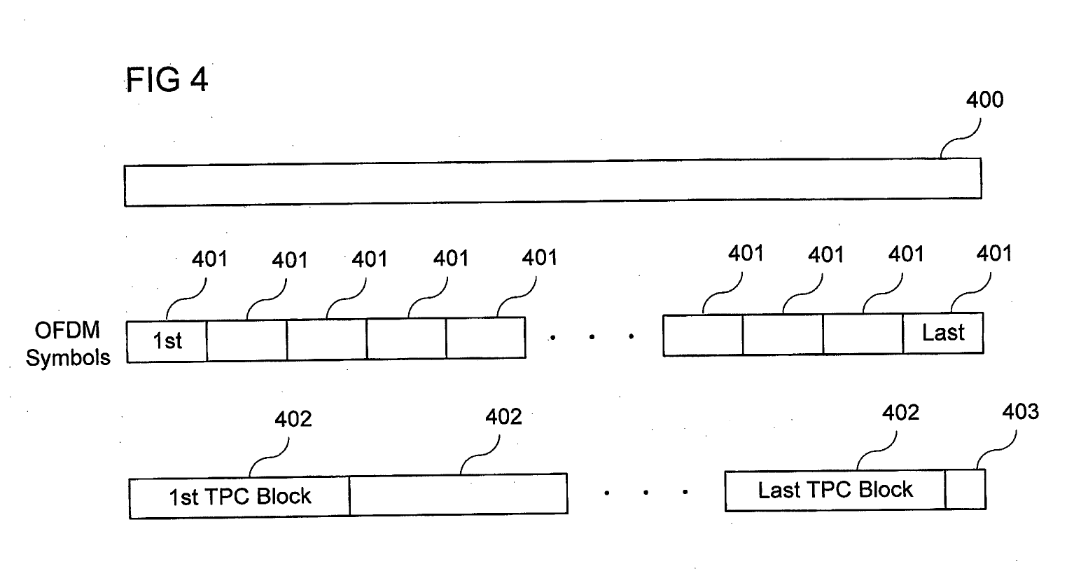

In this embodiment, an OFDM (symbol) frame refers to a data structure including exactly Q OFDM symbols of equal length and size. The relation of the OFDM frames and the TPC blocks is illustrated in FIG. 4.

FIG. 4 shows an OFDM frame 400 according to an embodiment.

As mentioned above, the OFDM frame 400 includes a plurality of OFDM symbols 401. The OFDM symbols 401 correspond to a plurality of TPC blocks 402 from which they are generated, i.e. the data of the TPC blocks 402 is mapped to the OFDM symbols 401, e.g. using constellation mapping according to the modulation scheme used. This means that for example, the first of the OFDM symbols 401 is generated from the first bits of the first of the TPC blocks 402, i.e. modulation symbols for each sub-carrier are selected according to these bits, the second of the OFDM symbols 401 is generated from the following bits of the first of the TPC blocks 402 and so on.

In one embodiment, the size of the TPC blocks 402 is not matched to the size of the OFDM symbols 401. In particular, it may happen that padding bits 403 are needed to have enough bits for the last of the OFDM symbols 401.

Typically, a turbo product code corresponds to codes (when the input data block is written in matrix form, this may be seen as one code corresponding to the rows and the other code corresponding to the columns). These two codes, which are also referred to as the components of the turbo product code may be of the same type as well as the same size. In the following, the size of a code is used to refer to the code input data block size and/or the output code block size.

Possible types of components of a turbo product code are for example Parity Code, Hamming Code, Extended Hamming Code, BCH (Bose-Chaudhuri-Hocquenghem) Code. Any two of these examples may for example be used for a TPC (block) code. The selection of the components for the TPC code may for example be based on parameters such as for example the desired BER performance, the desired coding rate or the ease of implementation.

Table 2 shows examples for possible combinations of two codes of different size which are for example all of the same type, in this example Extended Hamming Code.

TABLE 2
Examples for Extended Hamming Code based TPC block
sizes

| Block Types | Data bits | Coded bits | |
|---|---|---|---|
| TPC (nₓ, kₓ) (n_{y}, k_{y}) | per Block | per Block | Coding Rate |
| TPC (128, 120) (128, 120) | 14400 | 16384 | 0.89 |
| TPC (128, 120) (64, 57) | 6840 | 8192 | 0.83 |
| TPC (64, 57) (64, 57) | 3249 | 4096 | 0.79 |
| TPC (64, 57) (32, 26) | 1482 | 2048 | 0.72 |
| TPC (32, 26) (32, 26) | 676 | 1024 | 0.66 |
| TPC (32, 26) (16, 11) | 286 | 512 | 0.55 |
| TPC (16, 11) (16, 11) | 121 | 256 | 0.47 |
| TPC (16, 11) (8, 4) | 44 | 128 | 0.34 |
| TPC (8, 4) (8, 4) | 16 | 64 | 0.25 |

The size of a turbo product code is thereby given as TPC(nₓ,kₓ)(n_{y},k_{y}) where (nₓ,kₓ) gives the size of the first component and (n_{y},k_{y}) gives the size of the second component such that nₓ times n_{y} is the number of bits of the respective output code block and kₓ times k_{y} is the number of bits of the respective input data block of the turbo product code.

Table 2 lists a range of Extended Hamming Code based TPC block sizes without shortening. In one embodiment, a TPC with a bigger size than (128, 120)(128, 120) may be used. It can be seen from table 2 that the code rates of the turbo product codes increase with the size.

Therefore, in one embodiment, the TPC with the largest size, e.g. among a plurality of given allowed turbo product codes, is used, for encoding a data block 302, at least partially.

In one embodiment, the basic approach is to maximize the block size of the TPC blocks for a OFDM frame which allows maximum code rate and coding gain. In one embodiment, encoding is performed according to the following:
i. Let there be P TPC blocks in an OFDM frame (i.e. corresponding to an OFDM frame as shown in FIG. 2) where P does not equal Q.
ii. The first P−1 TPC blocks are chosen such that they have the same size. These blocks are referred to as blocks of the primary block type of this OFDM frame. The last TPC block may be of a different size. This block is referred to as block of the alternative block type of this OFDM frame.
iii. The primary block type is selected based on the desired bit error rate (BER).
iv. The size of the alternative block type is selected to be smaller as or equal to the size of the primary block type. Typically, the error correcting performance of a code is higher when the block size is smaller. Thus, the overall error correcting performance in a frame is not constrained by the alternative block type.
v. Shortening may or may not be applied to the alternative block, i.e. the block of the alternative block type.

In other words, based on the desired bit error rate, a TPC code with a certain size is chosen. This TPC code is used to encode data of the data blocks 302 as input data blocks. The result are P−1 output code blocks which also referred to as TPC blocks in this example. These P−1 TPC blocks all have the same size. In addition to these P−1 TPC block, a Pth TPC block is generated. The P−1 TPC blocks and the Pth TPC block together form the bit sequence that is mapped to the OFDM symbols of an OFDM frame. Except for the case that P TPC blocks of the primary block size form a bit sequence of exactly the length that is mapped to one OFDM frame, the Pth TPC block will have to be shorter than the P−1 TPC blocks of primary block type. Accordingly, the TPC code by which the Pth TPC block is generated has a different size than the TPC code used to generate the P−1 TPC blocks of the primary block type. Accordingly, the size of the input data block from which the Pth TPC block, also referred to as the TPC block of the alternative block type, is generated to be smaller than the input data blocks from which the first P−1 TPC blocks are generated. This means that the data from the input data blocks 302, from which the P TPC output code blocks are generated are grouped into P−1 input data blocks of a first size and a Pth input data block of a second size smaller than the first size. For the first P−1 input data blocks a first coding scheme, e.g. a code of a first size, is used and for the Pth input data block a second coding scheme, e.g. a code of a second size smaller than the first size is used.

In the following, it is assumed that one input data block 302 includes exactly the amount of (useful) data that is transmitted using one OFDM data frame. It is further assumed that the data block 302 is of size L bit.

In one embodiment, a primary block type is selected, e.g. from a set of available block types, in other words TPC sizes, that has the highest coding rate among those primary block types that meet the BER requirement, i.e. that are suitable with regard to the BER requirement. The number P_{pb} of primary blocks, i.e. TPC blocks of primary block type, can be calculated as:

$${P}_{pb} = ⌊ \frac{L}{{U}_{pb}} ⌋ \qquad ( 1 )$$

where └*┘ denotes the floor function and U_{pb}=kₓ·k_{y} is the number of uncoded bits of the code of size TPC(nₓ,kₓ)(n_{y},k_{y}) that is used to generate the primary blocks. This means that U_{pb} is the input data block size of the turbo product code used to generate the primary blocks (referred to as the type of the primary code).

The remaining bits B_{ab} of the data block, i.e. the bits that are not part of input data blocks used to generate the primary blocks are used as input for a code (referred to as the alternative code) to generate the alternative block. B_{ab} may be calculated as

B_{ab}=L−P_{pb}·U_{pb} (2)

In one embodiment, the alternative block type is selected according to the following rule:
vi. From table 3, select the code type with the biggest size for the alternative block based on B_{ab}. Note that iv still applies.

TABLE 3
Examples for conditions to select the TPC
alternative code

| Condition | TPC Alternative Code Type |
|---|---|
| 3249 ≧ B_{ab} > 1482 | TPC (64, 57) (64, 57) |
| 1482 ≧ B_{ab} > 676 | TPC (64, 57), (32, 26) or |
| | TPC (32, 26) (64, 57) |
| 676 ≧ B_{ab} > 286 | TPC (32, 26) (32, 26) |
| 286 ≧ B_{ab} > 121 | TPC (32, 26) (16, 11) or |
| | TPC (16, 11) (32, 26) |
| 121 ≧ B_{ab} > 44 | TPC (16, 11) (16, 11) |
| 44 ≧ B_{ab} > 16 | TPC (16, 11) (8, 4) or |
| | TPC (8, 4) (16, 11) |
| 16 ≧ B_{ab} | TPC (8, 4) (8, 4) |

Table 3 is derived from an analysis of possible alternative codes. The conditions listed in table 3 serve only for illustration. Other combinations are possible, which for example arise from specific external conditions. For example, if the data block length is a multiple of 8 and the primary block size is TPC(32,36)(32,26) no odd boundaries in the conditions listed in the left column of table 3 are used. Table 3 only shows conditions up to a maximum size of TPC(64,57)(64,57). The selection scheme according to table 3 may also be extended to higher TPC sizes.

For the coding schemes that may be selected for the alternative code (and analogously for the coding schemes that may be selected for the primary code) information for the usage of these coding schemes may be stored in a memory of the transmitter 300. For example, program code for the execution of the various coding schemes may be stored. Further, parameter values for the various coding schemes (e.g. input block size etc.) may be stored for the various coding schemes. As an example, a specification may be stored for each coding scheme how the bits of the input data block have to be combined to generate the corresponding output data block according to this coding scheme.

As an example, let L=2896 bits. It is assumed that the channel conditions dictate that the TPC with the highest coding rate that may be used is given by TPC(32,26)(32,26). This means that the primary code is given by TPC(32,26)(32,26), wherein it is still assumed in this example that this refers to a TPC of the given size based on a combination of two Extended Hamming Codes.

From equation (1) it follows that

P_{pb}=4.

Equation (2) gives

B_{ab}=2896−4*676=192.

Based on table 3, the alternative block size is therefore chosen as TPC(16,11) (32,26) in this example.

In one embodiment, in order to achieve maximum code rate for a code, shortening (or puncturing) is employed to remove any padded bits that are redundant and therefore reduce the code rate.

For block codes row shortening, column shortening or a combination of both may be performed. Using both row and column shortening may lead to some difficulties in implementation if the data block size L is not known and is not fixed in advance. If the range of L is large and variable determining the optimal row and column shortening for every possible L is typically not trivial using VLSI (Very Large Scale Integration) logic.

In the following, embodiments in which row shortening is used are described. The described methods may also be used for column shortening.

In case that the primary blocks are generated as described above no shortening is required for the primary blocks. For the alternative block, the amount of shortening that may be desirable depends on B_{ab}.

Since B_{ab} is the number of data bits used to generate the alternative block, the number of padding bits required for the alternative block (to have the full number of bits required for the input data block for the alternative code) is

B_{pad}=U_{ab}−B_{ab} (3)

where U_{ab} is the number of uncoded bits for the alternative block, i.e. the input data block size for the alternative code.

For the example above, where B_{ab}=192,

B_{pad}=286−192=94.

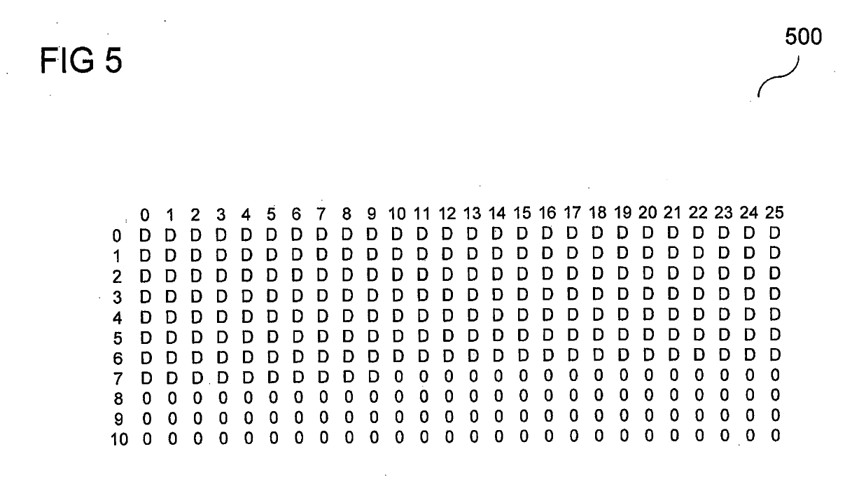

The input data block before encoding to be coded according to TPC(32,26) (16,11) with padding bits is shown in FIG. 5.

FIG. 5 shows a input data block 500 according to an embodiment.

As can be seen the rows numbered 8, 9, 10 all consist of padding bits (3*26=78 padding bits). Together with the 16 zeros in the row numbered 7, these form the 94 padding bits.

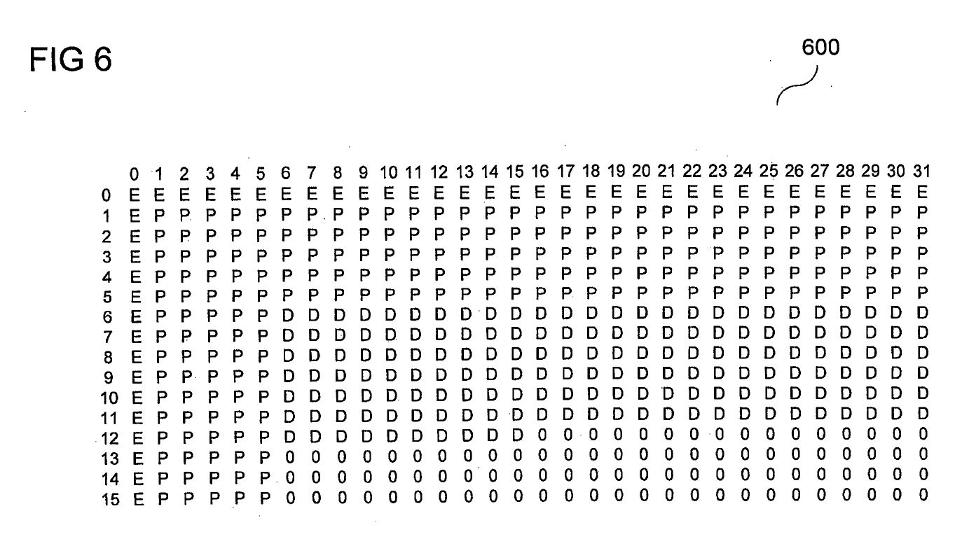

FIG. 6 shows an output code block 600 according to an embodiment.

The output code block is the TPC block that is generated from the input data block 300 shown in FIG. 5 according to TPC(32,26)(16,11). The last three rows (rows numbered 13, 14, 15) can be shortened (e.g. left out before passing the TPC block to the modulation circuit 305) in this example since all bits are zeroes.

For row number 12, where not all bits are zero, there are for example two options:

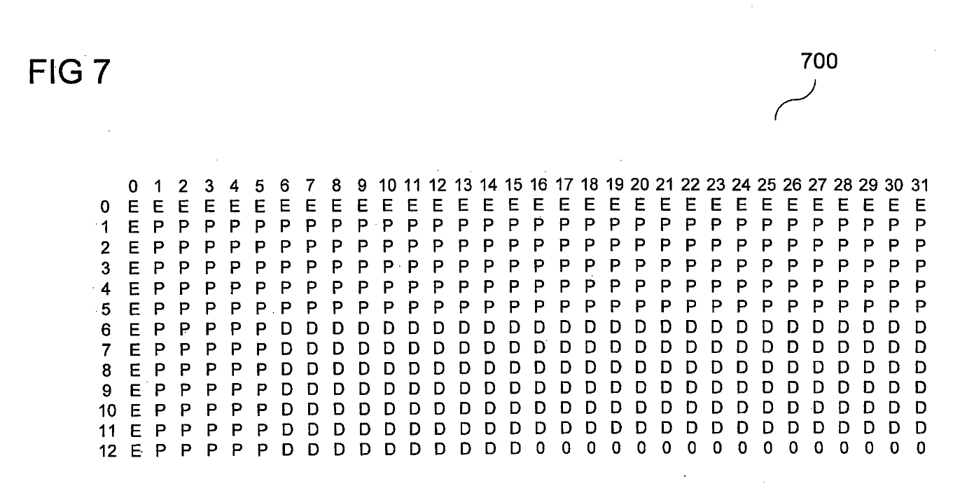

Option 1: Ignore the zero bits in the row and transmit the entire row (i.e. map the entire row to OFDM symbols). This is illustrated in FIG. 7.

FIG. 7 shows a shortened output code block 700 according to an embodiment.

In the shortened output code block 700, the last three rows including only zeroes have been removed but the residue zero bits arising from padding in row number 12, i.e. the last row including actual useful data bits have not been removed.

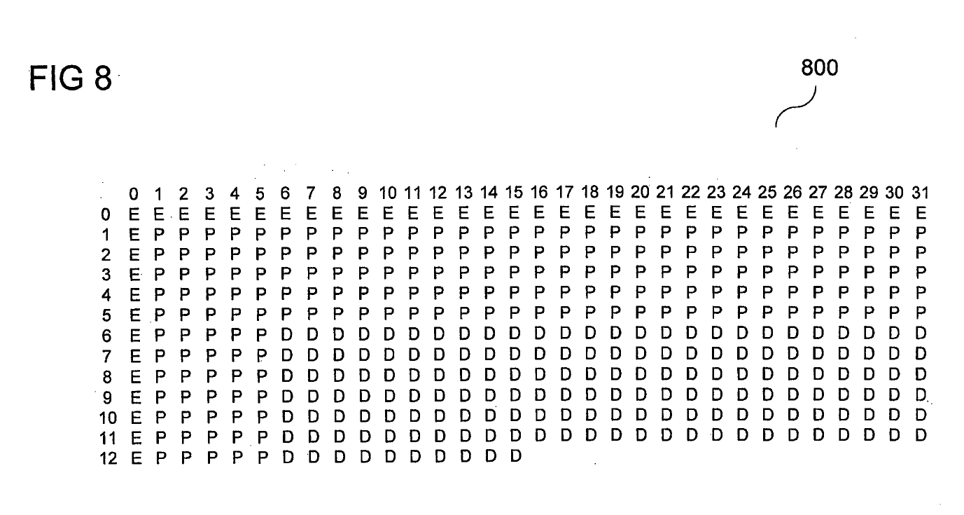

Option 2: Remove the zero bits (arising from padding) before transmission. This is illustrated in FIG. 8.

FIG. 8 shows a shortened output code block 800 according to an embodiment.

In the shortened output code block 800, the last three rows including only zeroes have been removed and the residue zero bits arising from padding in row number 12, i.e. the last row including actual useful data bits, have also been removed.

The choice between option 1 and option 2 is based on a trade-off between implementation complexity and coding rate. If the data block size L is big, the zero bits in the last TPC rows with valid data (in other words useful data; row 12 in the above example) does not affect the coding rate significantly.

The number of bits in the TPC block after shortening may be calculated by first determining the number of padded rows according to

$${N}_{pad} = ⌊ \frac{{B}_{pad}}{{k}_{x}} ⌋ \qquad ( 4 )$$

where └*┘ is the floor function, B_{pad} is given by equation (3) and kₓ is the number of uncoded data bits per row of the TPC block.

For the above example with L=2896 and B_{pad}=94

N_{pad}=3.

The number of coded bits per TPC block after shortening may be calculated for option 1 as

C_{ab}_{_{—}}_{pad}=C_{ab}−N_{pad}·nₓ (5)

and for option 2 as

C_{ab}_{_{—}}_{pad}=C_{ab}−N_{pad}·nₓ−B_{pad} mod kₓ (6)

where C_{ab}=nₓ·n_{y} for a size TPC(nₓ,k_{y}) (n_{y},k_{y}) is the number of coded bits in the alternative block.

The coding rate for the TPC blocks can be calculated as

$${Rate}_{TPC} = \frac{{P}_{pb} \cdot {U}_{pb} + {B}_{ab}}{{P}_{pb} \cdot {C}_{pb} + {C}_{ab \_ pad}} \qquad ( 7 )$$

where └*┘ is the floor function and C_{pb}=nₓ·n_{y} is the number of coded bits in a primary block of size TPC(nₓ,k_{y})(n_{y},k_{y}). C_{ab}=kₓ·k_{y} is the number of uncoded bits for a primary block (i.e. the number of bits of the input data block for a primary block). B_{pad} is given by equation 3, C_{ab}_{_{—}}_{pad} is given by equations 5 or 6, respectively.

To calculate the true coding rate of the system, the mapping of coded bits to OFDM symbols is considered. From FIG. 2, it can be seen that the total number of coded bits (i.e. the bits of the TPC blocks 402), possibly after shortening, does not fit into an OFDM symbol. Accordingly padding bits 403 for the last OFDM symbol are used.

Let the total number of coded bits transmitted using an OFDM symbol frame be denoted as Cₜₒₜₐₗ. This is given by

Cₜₒₜₐₗ=P_{pb}·C_{pb}+C_{ab}_{_{—}}_{pad}. (8)

To determine the number of OFDM symbols in an OFDM frame let N_{cbps} be the number of coded bits per OFDM symbol, i.e. the number of coded bits that are transmitted using one OFDM symbol. This value is for example determined by the modulation scheme (QAM64, PSK, . . . ) and the number of sub-carriers that are used. The number of OFDM symbols per OFDM frame is then given by

$${N}_{ofdm\_sym} = ⌈ \frac{{C}_{total}}{{N}_{cbps}} ⌉ \qquad ( 9 )$$

where ┌*┐ is the ceiling function.

The coding rate, taking into account a possible padding for the last OFDM symbol, is thus given by

$${Rate}_{Frame} = \frac{{P}_{pb} \cdot {U}_{pb} + {B}_{ab}}{{N}_{ofdm\_sym} \cdot {N}_{cbps}} . \qquad ( 10 )$$

It can be seen that the coding rate depends on the alternative block and the number of padding bits for the last OFDM symbol.

To ensure a consistent high code rate, in one embodiment, one or more of the following guidelines are followed:
The data block length L is chosen to be large;
The data block length L is chosen such that the number of padding bits for the last OFDM symbol is minimal;
If row shortening is employed the TPC block row size is chosen such that it is smaller than the TPC column size if the row size and the column size are not equal. If column shortening is employed (e.g. analogously to the row shortening described above), the TPC column size is chosen to be smaller than the row size if they are not equal.

In one embodiment, a method for formulating or designing Turbo Product codes for an OFDM based system is provided. Higher coding rates with good coding gains can be achieved when compared to existing systems. In one embodiment, the encoding is simple to implement and provides higher flexibility in the selection of TPC codes. Further, the following advantages can be achieved compared to conventional OFDM based systems using TPC codes:
A higher coding rate is possible without sacrificing BER performance;
The component codes used for TPC are not constrained to the TPC block size. This means that more powerful codes can be used, e.g. Extended Hamming Codes, instead of simple parity codes;
A larger range of data block lengths in a frame is possible;
There are no constraints on the OFDM symbol sizes from the TPC codes. Hence, the number of bits per OFDM symbol can be determined purely by channel conditions. This allows more flexibility during the design for the physical layer front end.
The method is simpler in implementation since the types of TPC blocks are limited. In one embodiment, only Extended Hamming Codes are used. Also, the shortening required for the design is very simple as compared to conventional schemes.

Embodiments of the invention may for be used for 3G systems, Wire LAN communication systems, optical communication systems, magnetic recording systems, and any communication systems that include channel codes. For example embodiments may be used for mobile communication systems according to 3GPP (Third Generation Partnership Project), FOMA (Freedom of Mobile Access), or CDMA2000 (CDMA: Code Division Multiple Access).

1. A method for encoding a bit sequence comprising
selecting a first coding block bit number and a first coding scheme;
sub-dividing the bit sequence into a plurality of first bit blocks and a second bit block, wherein each of the first bit blocks comprises the first coding block bit number of bits and the second bit block comprises less bits than the first coding block bit number;
selecting a second coding scheme for the second bit block different from the first coding scheme; and
encoding the first bit blocks using the first coding scheme and encoding the second bit block using the second coding scheme.

2. The method according to claim 1, wherein the second coding scheme is selected based on the number of bits of the second bit block.

3. The method according to claim 2, wherein the second coding scheme is selected such that the input block size of the second coding scheme is larger than the number of bits of the second bit block.

4. The method according to claim 3, wherein the second coding scheme is selected as the coding scheme of a plurality of second coding schemes that has the minimum input block size of the plurality of second coding schemes that is larger than the number of bits of the second bit block.

5. The method according to claim 1, wherein the first coding block bit number is selected in accordance with the input block size of the first coding scheme.

6. The method according to claim 1, wherein the bit sequence is encoded for a transmission of the bit sequence and the first coding scheme is selected based on a maximum allowed bit error rate of the transmission.

7. The method according to claim 6, wherein based on the maximum allowed bit error rate, a plurality of coding schemes which are suitable for the maximum allowed bit error rate are selected and the first coding scheme is selected as the coding scheme of the plurality of coding schemes having at least one of the highest coding rate and the highest coding gain.

8. The method according to claim 1, wherein the first coding scheme is a product code.

9. The method according to claim 8, wherein the first coding scheme is a turbo product code.

10. The method according to claim 9, wherein the first coding scheme is a turbo product code based on two Extended Hamming Codes.

11. The method according to claim 1, wherein the second coding scheme is a product code.

12. The method according to claim 11, wherein the second coding scheme is a turbo product code.

13. The method according to claim 12, wherein the second coding scheme is a turbo product code based on two Extended Hamming Codes.

14. The method according to claim 1, further comprising transmitting the encoded first bit blocks and the encoded second bit block.

15. The method according to claim 14, wherein the encoded first bit blocks and the encoded second bit block are transmitted according to OFDM.

16. The method according to claim 1, further comprising mapping the data of the encoded first bit blocks and the data of the encoded second bit block to modulation symbols.

17. The method according to claim 16, further comprising mapping the data of the encoded first bit blocks and the data of the encoded second bit block to OFDM symbols.

18. The method according to claim 17, wherein the data amount of the encoded first bit blocks is different from the amount of data that is mapped to one OFDM symbol.

19. The method according to claim 18, wherein the data of the encoded first bit blocks are mapped to at least two OFDM symbols.

20. The method according to claim 17, wherein the data amount of the encoded second bit block is different from the amount of data that is mapped to one OFDM symbol.

21. The method according to claim 1, further comprising bit padding the second bit block to be suitable as input for the second coding scheme.

22. The method according to claim 21, further comprising omitting at least some of the zero bits from the encoded second bit block that arise from encoding the padding bits.

23. The method according to claims 22, further comprising omitting all zero bits from the encoded second bit block that arise from encoding the padding bits.

24. An encoding circuit for encoding a bit sequence comprising
a first selecting circuit configured to select a first coding block bit number and a first coding scheme;
a sub-dividing circuit configured to sub-divide the bit sequence into a plurality of first bit blocks and a second bit block, wherein each of the plurality of first bit blocks comprises the first coding block bit number of bits and the second bit block comprises less bits than the first coding block bit number;
a second selecting circuit configured to select a second coding scheme for the second bit block different from the first coding scheme; and
a processing circuit configured to encode the plurality of first bit blocks using the first coding scheme and to encode the second bit block using the second coding scheme.

25. A computer program product, which, when executed by a computer, makes the computer perform a method for encoding a bit sequence comprising
selecting a first coding block bit number and a first coding scheme;
sub-dividing the bit sequence into a plurality of first bit blocks and a second bit block, wherein each of the first bit blocks comprises the first coding block bit number of bits and the second bit block comprises less bits than the first coding block bit number;
selecting a second coding scheme for the second bit block different from the first coding scheme; and
encoding the first bit blocks using the first coding scheme and encoding the second bit block using the second coding scheme.
